(19) United States
(12) Patent Application Publication
(10) Pub. No.: US 2016/0110521 A1
(43) Pub. Date: Apr. 21, 2016

(54) METHOD OF GENERATING A STRUCTURED PROGRAM OF ADAPTED PHYSICAL ACTIVITIES, AND WHICH IS ARTICULATED TEMPORALLY WITH A PROGRAM OF FEEDING ACTIVITIES

(71) Applicant: BIOMOUV, Montpellier (FR)

(72) Inventor: SEBASTIEN MARCEL PASCAL, MONTPELLIER (FR)

(73) Assignee: BIOMOUV, MONTPELLIER (FR)

(21) Appl. No.: 14/653,111

(22) PCT Filed: Dec. 18, 2013
(86) PCT No.: PCT/FR2013/053172

§ 371 Date: Dec. 13, 2015

(30) Foreign Application Priority Data
Dec. 18, 2012 (FR) 1262244

(51) Int. Cl. G06F 19/00

(52) U.S. Cl. CPC G06F 19/3475; G06F 19/3481

(57) ABSTRACT

The method of generating a structured program defines physical, biological and/or physiological needs and objectives of a subject. A structured program of adapted physical and feeding activities is established based on the temporal articulation variables and provided to the subject by way of a terminal. During the course of a session of adapted and structured physical activities of the program, a physical state and/or a physical activity of the subject is captured through the physiological and/or motion sensors. During the course of the session, the physical activity, the feeding activity associated with the adapted and structured physical activity of the session in progress and articulation temporal variables are adjusted.

### TECHNICAL FIELD OF THE INVENTION

The present invention relates to a method and a device for generating a structured program of adapted physical activities, articulated temporally with a program of feeding activities. The structured program of adapted physical activities (APA), in which structured APA sessions are constructed dynamically, adjusted in real-time and coupled with nutritional recommendations, on the one hand, and the program of feeding activities, on the other hand, are articulated to each other according to temporal variables and are generated based on a user's profile and/or their physical, biological and physiological needs. This invention applies in particular to computer-assisted sporting and nutrition mentoring, and to computer-assisted rehabilitation.

### STATE OF THE ART

Systems currently exist that generate programs integrating both dimensions: food and physical activities. But these programs do not articulate the two dimensions in relation to each other.

Methods, described but non-existent, envisage the articulation of a program of feeding activities and a program of physical activities. However, none of these described methods generates a program based on a temporal structure and on the reciprocal organization of physical activities and feeding activities.

Some known systems for monitoring physical activities, for example based on cardiofrequencemeters, show a user that their heart rate is too high or too low, relative to a target heart rate, during a sporting and physical activity that they are performing. Nevertheless, these systems do not make it possible to guarantee the optimum effectiveness of the program of structured adapted physical activities.

In addition, with these systems, some exercises are likely to be ineffective if repeated far too many times, for too long and/or too intensively, relative to what the organism is able to supply as effort. In addition, these exercises can also become a source of weakness, of injury or, more generally, of risk for the organism.

### SUBJECT OF THE INVENTION

The present invention aims to remedy all or part of these drawbacks.

To this end, the present invention envisages, according to a first aspect, a method defined in claim 1.

It is now noted that, according to the present invention, the term “physical” includes physiological and biological values.

The definition of the temporal articulation variables of the programs of adapted physical activities and feeding activities is established based on the subject's profile. These temporal variables make it possible to offer the subject an optimum schedule for their activities (physical and feeding) so as to best respond to their needs and reach the identified objectives (physical, biological and/or physiological) most effectively. For example, for a subject who is 56 years old and has type 2 diabetes and whose main objective is blood sugar control, the proposal is a session of moderate-intensity structured adapted physical activities three hours after lunch to obtain an optimum effect (therefore, in this specific case, the temporal articulation variable is three hours (reference: Impact of Time Interval from the Last Meal on Glucose Response to Exercise in Subjects with Type 2 Diabetes, Poirier et al., 2000)).

The presence of physiological and/or movement sensors, allowing a physical state and/or a physical activity of the subject to be captured when they perform each structured adapted physical activity, makes it possible to adjust the content of the current session, and if necessary to adjust, after the session, the content of the structured program of adapted physical activities, the content of the program of feeding activities, and the temporal articulation variables, according to the profile and objectives adjusted with regard to the data captured during the session. These adjustments make it possible to optimize the effectiveness of the program and to prevent a risk of injury or accident to the subject's body or of the subject performing activities not very effective for their organism.

In addition, according to the type of sensors used, it is even possible to instantly assess the impact of an adapted physical activity on a given piece of physiological data for the subject. These captured data not only make it possible to adjust an activity that is being performed by reducing or increasing its intensity, but also to modify all of the activities and recoveries of the session, their duration and their organization, and if necessary to modify all of the program's sessions at the end of the session.

In some embodiments, the step of defining a subject profile comprises a step of specifying a terminal user subject profile, a profile that comprises as data at least the subject's size and weight, and wherein the step of defining a structured program of adapted physical activities, a program of feeding activities and a temporal articulation variable is carried out based on at least one piece of profile data.

These embodiments allow a more precise definition of the structured program of adapted physical activities, of the program of feeding activities and of temporal articulation variables based on the data specified in a subject profile. The definition of the structured program of adapted physical activities, of the program of feeding activities and of temporal articulation variables becomes more precise as the amount of data specified by the subject increases.

In some embodiments, the data used during the profile specification step are obtained by at least one of the following means:
the user interface; and
communication with another terminal, a telemedicine tool; and
communication with another terminal.

These embodiments make it possible to obtain data relating to a subject's physical state, physical activity, food and health, even if there are no sensors, by using a user interface or data that is more detailed or already partially processed in the case of communication with another terminal or a telemedicine tool.

In some embodiments, the step of defining a subject profile comprises a step of estimating, by a terminal, the physical state and/or the physical activity according to data captured by physiological and/or movement sensors, and wherein the step of defining a structured program of adapted physical activities, a program of feeding activities and a temporal articulation variable is carried out based on the physical state and/or the physical activity estimated during the estimation step.

These embodiments allow a more precise definition of the program of adapted physical activities, of the program of feeding activities and of temporal articulation variables based on the estimated physical state and/or physical activity data and or the feeding behavior of a subject. The definition of the structured program of adapted physical activities, of the program of feeding activities and of temporal articulation variables becomes more precise as the amount of data captured increases.

In some embodiments, the data used during the step of estimating the physical state and/or the physical activity are obtained by at least one of the following means:

the user interface; and
communication with a telemedicine tool; and
communication with another terminal.

These embodiments make it possible to obtain data relating to a subject's physical state, physical activity, food and health, even if there are no sensors, by using a user interface or data that is more detailed or already partially processed in the case of communication with another terminal or a telemedicine tool.

In some embodiments, the method that is the subject of the present invention comprises, before the step of defining a structured program of adapted physical activities, a program of feeding activities and a temporal articulation variable, a step of describing, by means of the terminal, a feeding behavior of the subject comprising at least one piece of data from amongst:
an energy intake; and
a nutritional and/or dietary intake over a predefined period of time
   and wherein the step of defining a structured program of adapted physical activities is carried out based on at least one piece of data described during the description step.

These embodiments allow a more precise definition of the structured program of adapted physical activities, of the program of feeding activities and of temporal articulation variables based on the described dietary and nutritional data of a subject. In addition, the expected effect of the adapted physical activities on the subject's organism is reached more effectively and more precisely.

In some embodiments, the step of describing the subject's feeding behavior is performed by utilizing food quantity and/or food quality sensors.

These embodiments provide a quantitative and/or qualitative observation of the subject's diet that is objective and therefore more precise, and consequently allows a more appropriate definition of the structured program of adapted physical activities, of the program of feeding activities and of temporal articulation variables.

In some embodiments, the step of defining temporal variables allowing the articulation of the structured program of adapted physical activities and the program of feeding activities is performed based on the subject's needs and objectives defined in the profile definition step and on the physical, biological and/or physiological objectives defined in the objectives definition step.

In some embodiments, the method that is the subject of the present invention comprises:

a step of defining, by means of a terminal, a program of feeding activities, carried out according to at least one piece of profile data;

after the step of capturing a physical state and/or a physical activity of the subject, an iterative step of adjusting the content of the program of feeding activities on reception of and based on captured physical state and/or physical activity data; and

after the step of adjusting the content of the program of feeding activities, an iterative step of providing the subject, on a user interface of the terminal, with the program of feeding activities adjusted during the step of adjusting the program of feeding activities.

These embodiments provide many benefits. Firstly, they make it possible to optimize the effectiveness of sessions of the structured program of adapted physical activities according to the program of feeding activities as a whole, and vice versa. Secondly, they make it possible, at any time before, during and after an activity has been carried out, to suggest that the subject consume a foodstuff in order to restore their reserves of energy and of macro- and micronutrients with a view to the rest of the session or any other activity to come, or to optimize the effects of the current session. These embodiments make it possible to maximize the effects of the structured program of adapted physical activities according to a subject's energy and nutritional intakes and vice versa.

In some embodiments, the method that is the subject of the present invention comprises, before the step of defining a structured program of adapted physical activities, the program of feeding activities and temporal articulation variables, a step of defining at least one objective and wherein the step of defining a structured program of adapted physical activities, the program of feeding activities and temporal articulation variables is carried out based on at least one objective established during the step of establishing objectives.

These embodiments allow a more personalized definition of a structured program of adapted physical activities, of the program of feeding activities and of temporal articulation variables, insofar as the objective to be reached is quantified, qualified and/or declared.

In some embodiments, the method that is the subject of the present invention also comprises:
a step of adjusting the structured program of adapted physical activities, the program of feeding activities and the temporal articulation variables based on captured physical state and/or physical activity data; and
a step of providing the subject, on a user interface of a terminal, with the adjusted content of the structured program of adapted physical activities and the program of feeding activities.

The advantage of these embodiments is that it makes it possible to adjust not only the current session but also the structured program of adapted physical activities and the program of feeding activities, according to data used during the definition step.

The present invention envisages, according to a second aspect, a device according to claim 12.

As the particular features, advantages and aims of this device are similar to those of the method that is the subject of the present invention, they are not repeated here.

### BRIEF DESCRIPTION OF THE FIGURES

Other advantages, aims and features of the invention will become apparent from the description that follows of a particular embodiment of the method and the device for generating a personalized program of adapted physical and sporting activities, with reference to drawings included in an appendix, wherein:

FIGS. 1A and 1B represent a logical diagram of steps in a particular embodiment of the method that is the subject of the present invention; and

FIG. 2 represents, schematically, a particular embodiment of the device that is the subject of the present invention.

### DESCRIPTION OF EXAMPLES OF REALIZATION OF THE INVENTION

Note that the figures are not to scale.

“Structured program of adapted physical activities” means a program comprised of sessions of physical activities that are adapted and structured. This “structured program of adapted physical activities” can also comprise unstructured adapted physical activities.

1—The Physical Activities

The term “adapted physical activities” refers to any body movement produced by contracting skeletal muscles resulting in an increase in energy expenditure above the resting expenditure (reference: “Activité physique et santé, arguments scientifiques, pistes pratiques, Synthèses du programme national nutrition santé” [Physical activity and health, scientific arguments, practical approaches, Summaries from the national nutrition and health program] edited by the Société Française de Nutrition [French Society for Nutrition] under the Direction of Jean-Michel Oppert) and constructed according to the user's profile and their physical, biological and physiological needs. These activities also include sporting activities.

The term “structured physical activities” refers to activities characterized by one or more body movements (exercises) repeated a certain number of times, performed over a certain period of time, at a certain intensity, and interspersed with a longer or shorter recovery times entailing a greater or lesser level of activity by the subject (e.g. active, semi-active or passive recovery).

Therefore, the term “structured adapted physical activities” refers to activities that combine the characteristics of structured physical activities and adapted physical activities described above.

For example, for a subject who is morbidly obese (IMC=40), suffers from arthrosis of the knee and is completely out of condition, the main objective is to lose weight thanks to the highest level of energy expenditure they are capable of. A structured adapted physical activities content that might be proposed in sessions of their structured program would be, for example, an intermittent sequence of pool-walking, alternating 45 s at 55% of VO2max and 1 min of active recovery at 40% of VO2max, repeated seven times.

The term “unstructured adapted physical activities” refers to physical activities adapted to the needs of the user that can be carried out over a course of time and at intensities that are not specified precisely. For example, a physical activity for a sedentary person that has as its content taking a minimum of 10,000 steps each day is considered to be unstructured because, although its content is adapted to the needs of the subject, it does not indicate at what time all or part of this activity must be performed. Neither does it indicate precisely the intensity of the effort to be produced, the time and the nature of the recoveries, etc.

2—The Sessions

The term “sessions of structured adapted physical activities” refers to sessions comprising structured adapted physical activities, i.e. constructed according to a subject profile, identified objectives/needs organized in relation to each other to generate a specific physiological effort: intra-session structuring.

Each session therefore comprises a certain number of:
structured adapted physical activities that a person must perform; and
recovery times.

3—The Program

The term “structured program of adapted physical activities” refers to a program comprising at least one set of sessions of structured adapted physical activities, and possibly unstructured adapted physical activities.

What “Structured” Means:

The structured program of adapted physical activities is therefore distinguished from a program of adapted physical activities insofar as it necessarily proposes sessions of adapted physical activities that are structured with respect to each other (variable recovery times between two sessions taken into account based on their content, sessions organized with respect to each other according to their content). Thus, this involves inter-session structuring with precise timings, and a construction based upon the subject's profile and identified objectives.

What “Adapted” Means:

A structured program of adapted physical activities is distinguished from a structured program of physical activities insofar as the activities it consists of are adapted to the subject's profile and needs.

A “structured program of adapted physical activities” therefore comprises physical activities adapted to the subject's profile and structured with respect to each other within sessions (intra-session structuring), which have precise timings based on the subject's profile (inter-session structuring). This type of program can also comprise unstructured adapted physical activities, as defined above. For example, for a 56-year old sedentary subject, newly diagnosed with type 2 diabetes, with weak muscle mass and low muscle strength, and whose main objective is an improved lipid profile, the structured program of adapted physical activities would consist of:
a certain number of objectives to be achieved with respect to their unstructured physical activity: achieve a minimum of 6,000 steps each day and achieve a minimum of 200 minutes of moderate activities each week;
three sessions of structured adapted physical activities: two sessions mainly consisting of continuous activity with an intensity of 40% of VO2max and one session where the main activity is resistance work.

The two continuous activity sessions are each 45 minutes long, and the resistance work session is 35 minutes long.

These sessions are organized with respect to each other according to the following principles:
the two continuous activity sessions require a minimum recovery time of 24 hrs
the mainly “resistance work” session requires a recovery time of 48 hrs.

The subject will therefore have a continuous activity session on Monday, a resistance work session on Wednesday and the second continuous activity session on Saturday.

The purpose of a structured program of adapted physical activities can be medical, aesthetic, rehabilitation, physical fitness, or to prepare for a sports competition. In all cases, the aim above all is effectiveness with regard to the effects sought (objectives).

Each program, session of physical activities and physical activities, but above all each structure of program, sessions and activities comprising an organization of exercises and recoveries presents particular characteristics in terms of effort on the organism of the person carrying it out.

The inventors have discovered that the structured activities, sessions and programs can lose their effectiveness if they are not constructed with respect to a program and adapted feeding activities based on a precise time structure. Indeed, the temporal relationship that exists between a program, sessions and structured adapted physical activities, and a program and adapted feeding activities plays a key role in obtaining a physical, biological and/or physiological effect and achieving an objective. For example, elderly persons with sarcopenia are recommended to consume a large amount of protein in their mid-day meal (80% of the daily intake) to boost the protein balance and maximize the anabolic effect of this intake. In addition, this intake must include a sufficient amount of carbohydrates to cause the production of sufficient insulin, a hormone known for its anabolic effects. A further recommendation is to perform a session or physical activities of resistance exercises (structured adapted activities and session) to obtain a greater effect on the muscle mass and strength in the half-hour after the food intake.

The content of the structured program of adapted physical activities is therefore constructed based on the user's program of feeding activities.

The term “program of feeding activities” refers to a program proposing a certain number of food intakes.

These food intakes can, for example, comprise menus of complete meals consisting of a starter, main course and dessert. These intakes can also be snack suggestions, such as, for example, proposing an energy bar to a subject before, during or after a physical effort. The very nature of the food proposed for consumption by the subject will depend on the subject's profile and also on their physical and physiological state at that moment and on the physical activity to come (if their blood sugar level is too low and the subject is diabetic, then the program of feeding activities will propose, for example, that the subject eats a banana before their adapted physical activity session).

The number of these food intakes, their energy content and their content in terms of macro- and micronutrients are adapted to the user's profile, their physical and physiological objectives and to their programmed adapted physical activity.

This program of feeding activities is generated for an entire week so as to obtain nutritional balance respecting the attainment of recommended nutritional intakes adapted to the profile of each subject.

This program of feeding activities is also constructed based on at least one of the physical and physiological objectives to be achieved for a subject such as, for example, weight loss (the target daily energy intake is therefore slightly less that the energy expenditure), or weight stabilization (the target energy intake therefore equals the energy expenditure).

The objective therefore influences the target energy content of the food intakes but it can also influence the macro- and micronutrient content in each food intake. For example, in the case of a subject with osteoporosis the food intakes are generated so as to propose foodstuffs allowing a sufficient amount of calcium to be supplied to prevent worsening of the pathology. Similarly, for a pregnant woman the food intakes are generated so as to propose foodstuffs with a high folate content.

This program of feeding activities can also be constructed based on the structured program of adapted physical activities.

Throughout this description, by “program of feeding activities” we mean the schedule of feeding activities comprising the daily meals and/or snacks generated based on the user's profile, of at least one of the physical or physiological objectives to be achieved, and/or of the structured program of adapted physical activities, making it possible to achieve a target energy content and macro- and micronutrient contents in accordance with recommended nutritional intakes.

In addition to the structuring and temporal articulation of the programs of physical activities and feeding activities, the proposed sessions of structured adapted physical activities will only enable an optimum physiological effect to be obtained if they are regulated in real-time while they are carried out and if they are linked to nutritional recommendations (taking our previous example, it can be desirable to recommend before, during and after a session of resistance exercises the consumption of sufficient proteins and carbohydrates to boost muscle tissue synthesis. Secondly, it is essential to be able to adapt in real time the intensity, duration and structure of the activity proposed to the elderly person so as to instantly adapt the proposed effort according to the current capabilities, and to also adapt the number of repetitions of each exercise, the recovery instances and times, the number of series of repetitions, etc.).

Throughout the description, for reasons of clarity, we do not detail the memory operations and calls, regardless of the embodiment of the device considered.

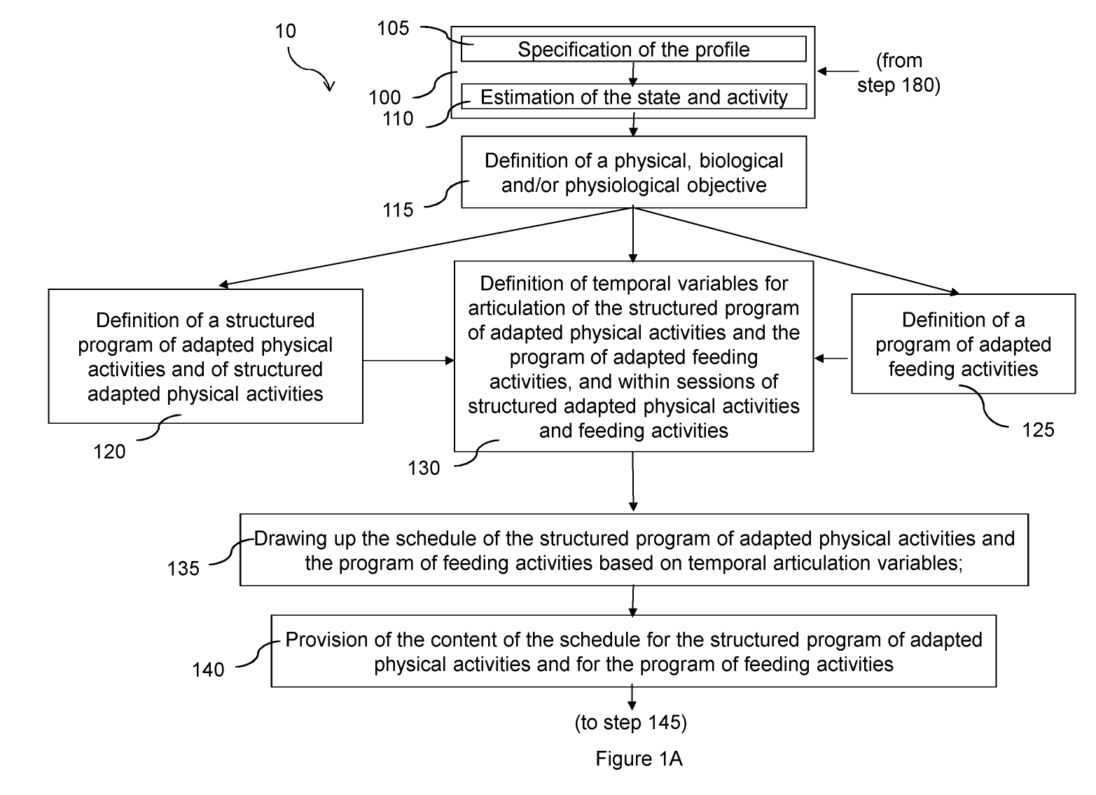

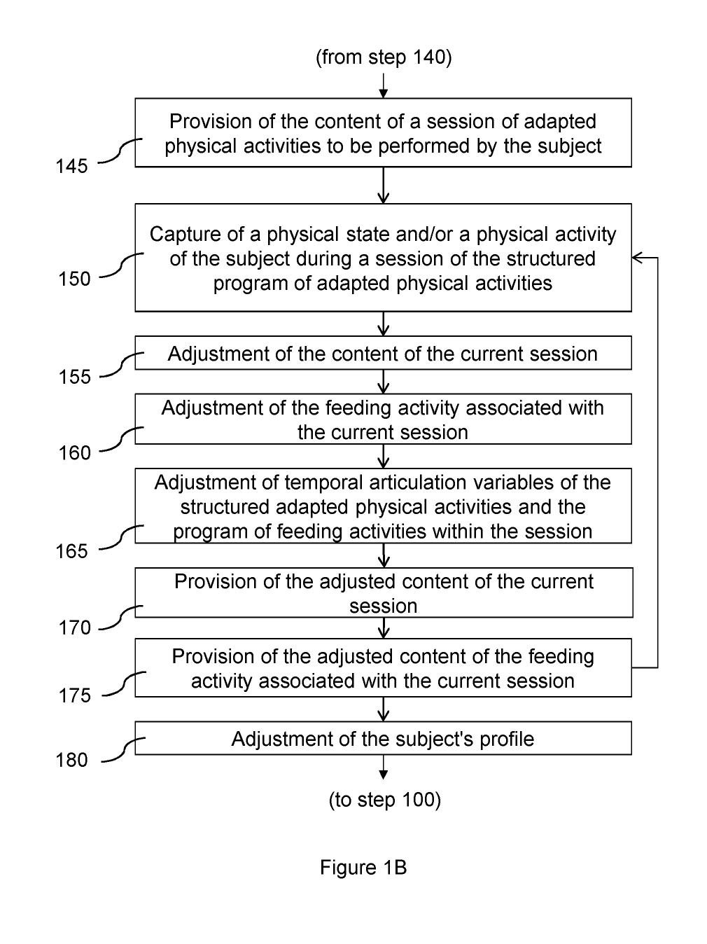

FIGS. 1A and 1B show the first embodiment of a method 10 of generating a structured program of adapted physical activities articulated according to the time interval to a program of adapted feeding activities, which comprises:

a step 100 of defining a subject profile comprising at least one of the following steps:
a step 105 of specifying a profile of a user of the terminal, or subject, a profile that comprises as data at least the subject's size and weight; and
a step 110 of estimating, by the terminal, the subject's physical state and physical activity according to data captured by physiological and/or movement sensors;

a step 115 of definition, by the subject, a third party or a terminal programmed for this purpose, establishing at least one physical, biological and/or physiological objective;

a step 120 of defining, by means of a terminal, the content of a structured program of adapted physical activities;

a step 125 of defining, by means of a terminal, a program of feeding activities; a content comprising at least one food intake to be carried out by a subject;

a step 130 of defining, by means of a terminal, temporal variables for articulation of the structured program of adapted physical activities and the program of adapted feeding activities, defined respectively in definition steps 120 and 125, and for articulation within the sessions of adapted physical activities and feeding activities also described in definition steps 120 and 125;

a step 135 of drawing up the schedule of the structured program of adapted physical activities and the program of adapted feeding activities based on the temporal articulation variables;

a step 140 of providing the subject, on the user interface of the terminal, with the content of the schedule established in step 135; and

a step 145 of providing the subject, on the user interface of the terminal, with the content of a session of structured adapted physical activities, a content comprising at least one type of structured adapted physical activity to be performed by a subject, (step 145 can be performed at the start of each session of activities);

iteratively, during a session of activities:
a step 150 of capturing a physical state and/or a physical activity of the subject, through the implementation of physiological and/or motion sensors, when the subject performs each adapted physical activity of the program defined during the definition step 120;
a step 155 of adjusting the current session;
a step 160 of adjusting the feeding activity associated with the current session, taking the adapted physical activity performed and the data captured into account;
a step 165 of adjusting temporal articulation variables of the structured adapted physical activities/feeding activities within the session;
a step 170 of providing the subject, on a user interface of the terminal, with the adjusted content of the current session; and
a step 175 of providing the subject, on a user interface of the terminal, with the adjusted content of the feeding activity associated with the current session; and

a step 180 of adjusting, by means of the terminal, the subject's profile.

The terminal implements a user interface. The terminal can be portable (a smartphone or a tablet), fixed (e.g. a server, an interactive television, a computer or an exercise bike) or comprise a fixed portion and a portable portion.

“Individual profile” (subject's profile) means here a set of data about an individual, for example:

personal data (size, weight, gender, age, etc.);
data concerning their physical activity (quantifying and qualifying their physical activity);
data concerning their well-being (stress, quality of life, sleep, etc.);
data concerning their physical state: strength, flexibility, anthropometric data, physiological data, neurophysiological data, biological data, etc.;
data concerning their diet (feeding behavior, content of the various macro- and micronutrients);
data concerning their health (coming from the activity or from the diagnosis by a health-care professional, telemedicine tools, a biological analysis, etc.).

“Personalized program” means here a structured program of adapted physical activities proposed to an individual and constructed on the basis of an analysis of their individual profile and of at least one objective selected by the subject, a third party or a terminal programmed for this purpose.

The specification step 105 can be carried out by entering fields on a user interface of a computer program contained in the terminal, by the subject themself, a third party, or a connection with another terminal or with a telemedicine system.

In some variants, the computer program is contained in a remote memory to which the terminal is connected and for which the terminal displays a user interface. Such data can comprise, for example, the subject's age, gender, size, weight, body mass index, the feeding behavior, and the food consumption. In addition, these data comprise, for example, medical data relating to the subject's illnesses and treatments.

In some variants, the subject's profile is downloaded from a remote memory. In other variants, during the specification step 105, the subject enters results to physical condition tests, responses to a questionnaire whose purpose is to determine their physical condition, for example. In other variants, at least one of the pieces of data is specified by the subject or a third party via a selection in a multiple-choice menu.

The step 110 of estimating the subject's physical state and/or physical activity is performed by implementing physiological and/or movement sensors connected to the terminal. Such sensors can comprise, for example, a cardiofrequencemeter, an electrocardiogram, an electroencephalogram, a tensiometer, a glucose meter, a thermometer, an actimeter, or impedance scales. Other information relating to the subject's physical state (such as a possible illness, for example) is obtained by the subject or a third party entering fields or appropriate menus on a computer program of the terminal. Additional or more precise information can also be obtained by the terminal communicating with telemedicine tools such as the Personal Medical File (Dossier Médical Personnel, for France), for example. The step 110 also allows the feeding behavior of the described subject to be estimated by utilizing food quantity and/or food quality sensors.

The step 115 of defining one or more objectives is also carried out by the subject or a third party entering fields or appropriate menus on a user interface of the terminal's computer program. In some variants this objective can be established by the computer program itself (or by an analysis program) based on data from the profile (step 100) and/or from captured data (step 150). These objectives can correspond to:

a weight or a percentage of fat or muscle mass to be reached, for example;

a physical, aesthetic, physical fitness, rehabilitation, health prevention effect;

a physiological effect such as, for example, a reduction in post-meal hyperglycemia;

preparing for a competition and physical preparation, and an amount or an intensity of sporting and physical activity to be performed.

The step 120 of defining a structured program consisting of sessions is carried out based on objectives defined during the step 115 of defining at least one objective. This program is also performed based on data specified in the subject's profile during the specification step 105, and on the physical state, physical activity and feeding behavior estimated in the estimation step 110. In a variant, the subject selects in a menu the physical and sporting activities they wish to perform during sessions of their program.

Step 120 comprises the definition of each session (repeated as many times as the program generates sessions), which is performed by a terminal taking into account at least one piece of data entered during the step 100 of defining the subject's profile.

The step 125 of defining a program of adapted feeding activities is carried out based on at least one objective established during the step 115 of establishing at least one objective. This program is also performed based on data specified in the subject's profile during the specification step 105, and on the physical state, physical activity and feeding behavior estimated in the estimation step 110. In some variants, the program is defined by the subject, a third party or a terminal programmed for this purpose selecting a number of food intakes to be included in the program of adapted feeding activities, and the frequency of these food intakes (e.g. daily, weekly). In a variant, the subject selects in a menu the meals, foodstuffs, preparations that they wish to have proposed in their program of adapted feeding activities, for example.

Step 125 comprises the definition of each food intake (repeated as many times as the program has generated intakes), which is performed by a terminal taking into account at least one piece of data entered during the step 100 of defining the subject's profile. Step 125 also comprises the definition of each food intake that can be associated, according to a temporal variation, to the different adapted physical activities performed by the user during the sessions.

Step 130 of defining temporal articulation variables is performed by a computer program incorporated into the terminal (server or terminal of the user) or by a third party taking into account at least one piece of data entered during the step 100 of defining the subject's profile.

Step 135 of drawing up the schedule of the personal program (structured program of adapted physical activities articulated with the program of adapted feeding activities) is performed by a computer program incorporated into the terminal (server or terminal of the user) taking into account the structured program of adapted physical activities defined in the definition step 120, the program of adapted feeding activities defined in the definition step 125, and temporal articulation variables defined in the definition step 130. This schedule comprises the number of sessions, the day when they take place, the recovery times between each of them. With regard to each session, it can for example comprise three phases (warm-up, main body of the session and end of the session), each comprising several structured adapted physical activities. This schedule also comprises the number of food intakes and the day when they take place. Each food intake comprises the dietary recommendations adapted to the person's profile and their physical activity. Lastly, this schedule comprises the time intervals that need to be observed between the food intakes and the sessions of structured adapted physical activities so as to optimize the effectiveness of the program.

Step 140 of providing the content of the schedule for the personal program is carried out by means of the subject's terminal. In some variants the content of the schedule is provided by displaying, on a screen of the subject's terminal, messages presenting the structured program of adapted physical activities articulated with the program of adapted feeding activities. In other variants, the content of the schedule for the personal program is provided by the emission of audible instructions.

Step 145 of providing the content of the session of structured adapted physical activities is carried out by means of the subject's terminal. In some variants the content is provided by graphical or visual display, such as for example in the form of videos or descriptive images. In other variants, the content of the session is provided by the emission of audible instructions.

The capture step 150 is performed by implementing suitable sensors measuring the cardiac activity, the blood sugar, the oxygen saturation, and the movement speed (in the case of a sporting and physical activity based on the subject's movement), for example. These data allow, in addition, a certain number of other indicators to be deduced making it possible to identify the inability to continue the exercise in particular. These sensors are placed on the subject's body or close to the subject.

The term “inability to continue an exercise” refers to a physical state indicated by:
an accumulation of metabolic by-products such as lactate;
phosphocreatine depletion during repeated maximum contractions;
progressive depletion of the substrates used for energy production such as glucose and glycogen;
a feeling of tiredness that is accompanied by reduced muscular performance; and
a feeling of fatigue expressed by the subject by using a microphone or a screen.

Known concepts in the field of energy systems are recalled below. We refer in particular to the writings of J. H. Wilmore and D. L. Costill in Physiology of Sport and Exercise, by Editions De Boeck.

For the ATP-CP energy production system, the inability to continue the exercise can coincide with phosphocreatine depletion during repeated maximum contractions (in muscle-development exercises or in sprints). In some embodiments of the present invention, this concerns in particular the sessions aimed at developing the anaerobic alactic energy pathway. For example, one indicator of the inability to continue the exercise implemented in these embodiments of the invention is the reduction in movement speed performances starting from a certain number of repetitions of the activity or the exercise; this can also be the level of the strengths and powers developed by the subject during certain “explosive” exercises (measurement of strengths and powers possible thanks to movement sensors). The performance threshold below which an inability to continue the exercise is concluded is defined thanks to data from the subject's profile.

For glycolysis, the substrates used for energy production are glucose and glycogen. Their progressive depletion during the effort helps to increase the feeling of exhaustion. A feeling of severe exhaustion appears when the stocks of glycogen have broken down completely. Based on the subject's heart rate during the effort, we can calculate the quantity of glucose and glycogen used (by applying theoretical models) and thus see to what extent the subject's (theoretical) stocks have been exhausted. In some embodiments, another indicator is the blood glucose level (this level can be measured with a glucose meter).

Lastly, the inability to continue the exercise is linked to the accumulation of metabolic by-products such as lactate. In some embodiments, an indicator of this inability is, for example, during all predominantly lactic sessions, above a certain duration of effort, performances dropping below a certain threshold. One indicator is, for example, the movement speed reducing below a certain threshold defined beforehand.

For preference, the data captured during the session are transmitted to the terminal.

Step 155 of adjusting the current session is performed by a computer program incorporated into the terminal (server or terminal of the user). This computer program analyzes the data captured during the step 150, assesses the subject's physical state and physical activity during the session and instantly adjusts the content and structure of the session (nature of the activity, repetitions, duration, intensity, nature of the recoveries, duration of the recoveries, for example).

Here is an example of a running session to illustrate the adjustment step 155. The objective of the session is to develop the subject's aerobic power. After the warm-up, the program proposes to the subject a first sequence of work in which they must perform eight repetitions of running for a duration of one minute at 120% of their maximum aerobic power (MAP) interspersed by active recoveries (running at 60% of their MAP). Checking that the thresholds of 120% and 60% of the MAP have been reached is made possible by monitoring the movement speed (thanks to the MAP to maximum aerobic speed relationship). The subject manages to perform this sequence of work correctly.

The program then specifies a second sequence of work whose nature is as follows: six repetitions of running for a duration of one minute and 30 seconds at 120% of their MAP interspersed by active recoveries of two minutes and fifteen seconds (at 60% of their MAP). However, as of the third repetition, the subject's movement speed drops significantly even though their heart rate is at maximum. This is an indicator of a very large premature lactic acid build-up that prevents the subject from continuing their effort as it was programmed. The computer program therefore immediately adjusts the content of the session and replaces the sequence initially specified by a new sequence: ten minutes of recovery thanks to running at 50% of their MAP followed, after a pause of two minutes' stretching exercises, by an additional 10 minutes to allow a complete recovery before passing on to a new exercise sequence.

Step 160 of adjusting the feeding activity associated with the current session is performed by a computer program incorporated into the terminal (server or terminal of the subject). This computer program analyzes the data captured during the step 150, assesses the subject's physical state and physical activity during the session. This program quantifies and qualifies the subject's immediate or future food needs, and, based on the temporal articulation variables, immediately adjusts the content of the feeding activity associated with the current adapted physical activity (quality and quantity of the food snack) to maximize the effects of the program of adapted physical activities and avoid a danger to the subject.

Step 165 of adjusting temporal articulation variables making it possible to articulate the structured adapted physical activities and the feeding activity within the session is performed by a computer program incorporated into the terminal (server or terminal of the subject). This computer program analyzes the data captured (e.g. the blood sugar, movement speed, etc.) during the step 150 and, if necessary, adjusts the time interval between the current structured adapted physical activity and the associated feeding activity, which consists of snack food intake(s).

Here is an example of adjusting the adapted feeding activity during a session of structured adapted physical activities. The objective of the session is to improve the insulin sensitivity of a type 2 diabetic patient. A session has been programmed for five hours after the lunch food intake. Based on the patient's profile and their therapy, the program has generated a session of structured adapted physical activities comprising amongst others three 10-minute continuous activity sequences of cycling, each at 55% of VO2max. The subject's blood sugar is captured at the beginning of the session, and it has a level of 100 mg/dL. With regard to this value, analyzed as too low for the structured adapted physical activity specified, the computer program adjusting the feeding activity and the program adjusting the temporal articulation variable then sends a suggestion to immediately consume a snack of 20 g of carbohydrates and schedules a second suggestion at the end of 30 minutes after the three 10-minute cycling sequences have been completed. After the three cycling sequences have been carried out, an inability to continue the session's activities is detected thanks to movement sensors and blood sugar data. The computer program for adjusting adapted physical activities adjusts the rest of the session, proposing a passive recovery time of five minutes then a three-minute continuous effort sequence at 40% of VO2max.

Step 170 of providing the adjusted content of the current session's structured adapted physical activities is performed by displaying, on a screen of the user's terminal, messages presenting the adjusted activity session, during the session. In some variants, the provision step 170 is performed by the user's terminal emitting audible messages. In other variants, step 170 is performed by this terminal providing audiovisual messages. These messages present the adjusted content of the current session.

Step 175 of providing the adjusted content of adapted feeding activities associated with the current session is performed by displaying, on a screen of the user's terminal, messages presenting the adjusted feeding activity, during the session. In some variants, the provision step 175 is performed by the user's terminal emitting audible messages. In other variants, step 175 is performed by this terminal providing audiovisual messages. These messages present the adjusted content of the current session.

Step 180 of adjusting the subject's profile is performed by a computer program incorporated into the user's terminal or on a remote server. This computer program collects and integrates all of the data captured during the session at step 150. After the session, the computer program assesses the subject's physical state and its development, and also the subject's physical activity during the session performed, and adjusts the subject's profile. Adjusting the subject's profile allows a new objective to be iteratively defined during the step 115 if the objective initially defined has been achieved.

The structured program of adapted physical activities, the program of feeding activities and the temporal articulation variables are then redefined iteratively during steps 120, 125 and 130 respectively, according to the adjustment of the user's profile (step 180) and, where applicable, to the redefinition of at least one of the user's objectives redefined during step 115.

In some embodiments of this method 10, the terminal memorizes the structured program of adapted physical activities and the captured physical state and/or physical activity data. In other embodiments of this method 10, the terminal is a communicating terminal and only operates as an interface, all of the data (defined, adjusted program and captured data) being memorized and processed by a distant memory (e.g. a server). This communicating terminal can be, for example, a smartphone connected to an Internet network by a Wi-Fi (registered trademark) connection or by data passing via a telephone network (e.g. 3G, 4G). In other embodiments, the data (defined, adjusted program and captured data) is memorized by a distant memory and/or the communicating terminal.

Therefore, in some embodiments of this method 10, a server contains the data relating to the profile specified during the specification step 105, to the physical state and to the physical activity estimated during the estimation step 110. The server performs step 120 of defining a structured program of adapted physical activities, step 125 of defining a program of feeding activities, step 130 of defining temporal articulation variables, and it transmits the programs defined in this way to the terminal. The terminal adjusts the sessions of structured adapted physical activities, the feeding activity associated with the current session, and temporal articulation variables within the session.

The server adjusts the user's profile during the profile definition step 100, according to the data captured during the capture step 150. It then, if necessary, adjusts at least one objective during the step 115 of establishing at least one objective, and adjusts the structured program of adapted physical activities, the program of feeding activities and the temporal articulation variables, as mentioned in the description of FIGS. 1A and 1B. The terminal displays the structured program of adapted physical activities, the session, and the program of feeding activities.

In some variants of this method 10, a server contains the data relating to the profile specified during the specification step 105, to the physical state and to the physical activity estimated during the estimation step 110, thus operating as a remote storage memory.

The terminal then performs all the definition, capture, adjustment, etc. operations of step 115 to step 180.

In other variants of the method 10, all of the operations are performed by the server except for displaying the programs of feeding and physical and sporting activities. These two programs are displayed on the terminal, step by step, according to the information sent by the server.

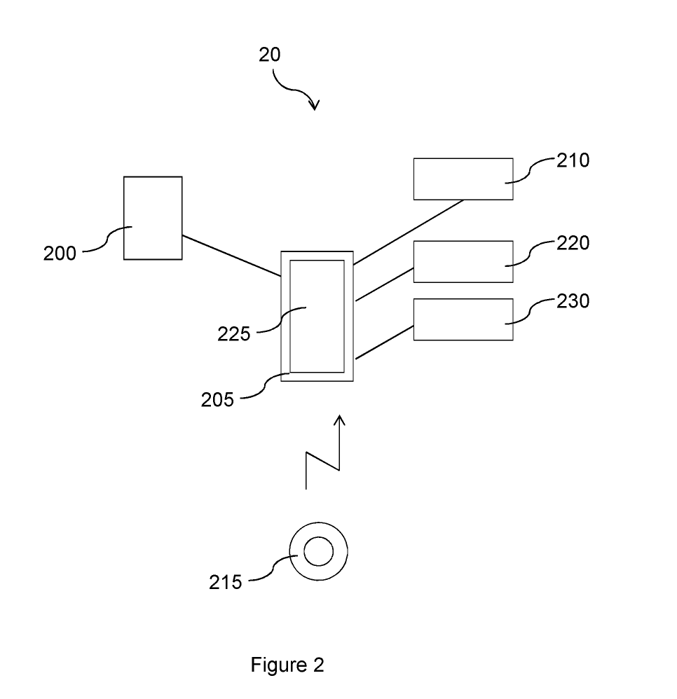

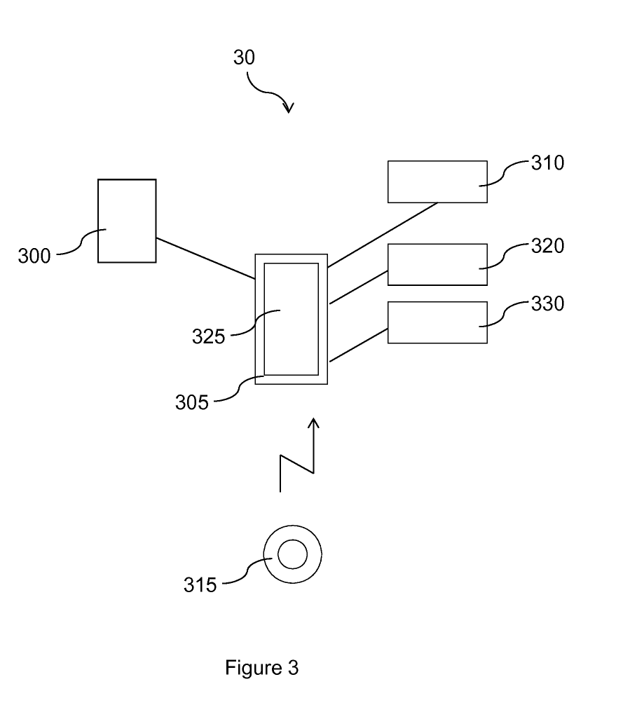

FIG. 2 shows a particular embodiment of the device 20 that is the subject of the present invention. This device 20 for generating a personalized adapted program of physical and sporting activities, which comprises:
a means 200 of defining a subject profile, and at least one physical, biological and/or physiological objective;
a user's terminal 205;
a means 210 of defining, by means of the terminal 205 and/or a server, the content of the schedule for the structured program of adapted physical activities and for the program of feeding activities according to temporal articulation variables;
a means 215 of capturing a physical state and/or a physical activity of the subject when the subject performs each sporting and physical activity of the defined program;
a means 220 of adjusting, by the terminal 205, according to the data captured, the content of the session being performed, constituted of structured adapted physical activities articulated with the adapted feeding activity based on the temporal articulation variables;
a means 225 of adjusting the content, by the terminal 205, of the subject's profile and at least one objective according to the data captured; and
a means 230 of adjusting the content of the structured program of adapted physical activities, the program of feeding activities and temporal articulation variables according to the profile and at least one objective adjusted by the adjustment means 225;
a means 235 of providing the subject, on a user interface of the terminal 205, with the adjusted structured program of adapted physical activities and the adjusted program of feeding activities adjusted by the means 230 of adjusting the content of the structured program of adapted physical activity, the program of adapted feeding activities and temporal articulation variables.

The means 200 of defining a subject profile can be, for example, a user interface of a computer program contained in a remote server. The terminal 205 can be portable (a smartphone), fixed (e.g. a server, an interactive television, a computer or an exercise bike) or comprise a fixed portion and a portable portion.

The means 210 of defining the content of a structured program of adapted physical activities is, in FIG. 2, a computer program contained in the terminal 205. The user interface of this computer program comprises a set of menus and fields to be filled in by the subject or a third party in order to define the program of activities.

The capture means 215 is achieved by a set of suitable sensors (e.g. tensiometer, cardiofrequencemeter, thermometer, glucose meter) connected to the subject's terminal 205.

The data produced by the capture means 215 are used by the means 220 of adjusting the content of the current session, by the means 225 of adjusting the user's profile and at least one objective, and by the means 230 of adjusting the content of the structured program of adapted physical activities, the program of feeding activities and temporal articulation variables. These adjustment means 220, 225 and 230 are computer programs that compare the captured date with targets to be achieved and consequently adjust the content of the current session and, respectively, the user's profile and at least one objective, and also the content of the structured program of adapted physical activities, of the program of feeding activities and temporal articulation variables. In some variants, these adjustment means 220, 225 and 230 compare the changes in the captured data with target changes and consequently adjust the content of the current session and, respectively, the user's profile and at least one objective, and also the content of the structured program of adapted physical activities, of the program of feeding activities and temporal articulation variables. In other variants, these means 220, 225 and 230 use the captured data to calculate other variables and compare the value of these variables to expected data. In a variant, the means 220, 225 and 230 are, at least partially, incorporated into the server.

The adjusted session, the adjusted structured program of adapted physical activities, and the adjusted program of feeding activities adjusted by the adjustment means 220 and 230, respectively, are provided on a user interface of the terminal 205 (such as a screen and/or a loudspeaker) by a provision means 235. This provision means 235 can be, for example, a controller of a screen and/or loudspeaker of the terminal 205.

The data captured by the capture means 215 or processed by the adjustment means 220 or 230 are used for adjusting the subject's profile by the adjustment means 225.

1-11. (canceled)

12. A method of generating a structured program of adapted physical activities articulated to a program of feeding activities according to a time interval, comprising the steps of:
defining a subject profile of a subject and at least one of physical, biological and physiological needs/objectives of the subject;
defining, according to the subject profile and the defined needs/objectives of the subject, a content of a structured program of adapted physical activities utilizing a user terminal associated with the subject, the content comprising sessions of at least one type of the structured adapted physical activity to be performed by the subject;
defining, according to the subject profile and to the defined needs/objectives, utilizing the user terminal, a content of a personalized program of adapted feeding activities, the content of the personalized program of adapted feeding activities comprising at least a schedule of food intakes associated with food menu suggestions;
defining, according to the subject profile, temporal articulation variables allowing, over a predefined time interval, to articulate, according to the predefined time interval, the structured program of adapted physical activities and the personalized program of feeding activities, and to articulate and within the sessions of adapted physical activities and feeding activities;
planning the structured program of adapted physical activities and the personalized program of adapted feeding activities based on the temporal articulation variables;
providing the subject, via the user terminal, with a session of the structured adapted physical activities to be performed, articulated with a feeding activity based on the temporal articulation variables;
iteratively performing the following steps:
capturing at least one of a physical state and a physical activity of the subject by at least one of physiological and motion sensors, during the session of the structured adapted physical activities of the structured program;
adjusting, during the session, the structured adapted physical activities of the session in progress, via the user terminal, based on said at least one of physical state and physical activity data of the subject captured by said at least one of physiological and motion sensors;
adjusting a feeding activity associated with the structured adapted physical activity of the session in progress;
adjusting temporal articulation variables of the structured adapted physical activities and of the feeding activities within the session; and
providing the subject, on a user interface of the user terminal, with the adjusted content of the structured adapted physical activities of the session in progress and of the feeding activities associated with said at least one at least one of physical state and physical activity data of the subject captured by said at least one of physiological and motion sensors;
adjusting, after the session, at least one of the subject profile and at least one of the defined needs/objectives of the subject; and
iteratively adjusting the structured program of adapted physical activities, the personal program of feeding activities and the temporal articulation variables based on adjustment to said at least one of the subject profile and said at least one of the defined needs/objectives of the subject.

13. Method according to claim 12, further comprising the steps of specifying the subject profile by the subject using the user terminal, the subject profile comprising a profile data of at least a size of the subject and a weight of subject; and defining the structured program of adapted physical activities and the personalized program of feeding activities based on at least one piece of the profile data.

14. Method according to claim 12, further comprising the step of obtaining a profile data from at least one of the following: a user interface of the user terminal, in communication with another terminal and in communication with a telemedicine tool.

15. Method according to claim 12, further comprising the steps of estimating said at least one of the physical state and the physical activity of the subject from the data captured by said at least one of physiological and motion sensors; and defining the structured program of adapted physical activities and the personalized program of feeding activities based an estimation of said at least one of the physical state and the physical activity.

16. Method according to claim 15, further comprising the step of obtaining data for estimating said at least one of the physical state and the physical activity from at least one of the following: a user interface of the user terminal, in communication with another terminal and in communication with a telemedicine tool.

17. Method according to claim 12, further comprising the steps of defining a feeding behavior data of the subject from at least one piece of following data: an energy intake of the subject, a nutritional intake over a predefined period of time, a dietary intake over the predefined period of time; and defining the structured program of adapted physical activities based on said at least one piece of the feeding behavior data of the subject.

18. Method according to claim 17, further comprising the step of obtaining the feeding behavior data from at least one of food quantity and food quality sensors.

19. Method according to claim 12, further comprising the step of defining the temporal articulation variables based on the subject profile.

20. Method according to claim 12, further comprising the steps of defining the personalized program of feeding activities, via the user terminal, in accordance with at least one piece of a profile data; iteratively adjusting the content of the personalized program of feeding activities based on said at least one of physical state and physical activity data of the subject captured by said at least one of physiological and motion sensors; and iteratively providing the adjusted content of the personalized program of feeding activities to the subject on a user interface of the user terminal.

21. Method according to claim 12, comprising the steps of adjusting the content of the structured program of adapted physical activities and the content of the personalized program of feeding activities based on said at least one of physical state and physical activity data of the subject captured by said at least one of physiological and motion sensors; and providing the adjusted content of the structured program of adapted physical activities and the adjusted content of the personalized program of feeding activities to the subject on a user interface of the user terminal.

22. A device for generating a structured program of adapted physical activities articulated to a program of feeding activities according to a time interval, comprising:
an user interface to define a subject profile of a subject and at least one of physical, biological and physiological needs/objectives of the subject;
a processing unit configured to:
define a content of a structured program of adapted physical activities, in accordance with the subject profile and the defined needs/objectives of the subject, the content comprising sessions of at least one type of the structured adapted physical activity to be performed by the subject;
define a content of a personalized program of adapted feeding activities, in accordance with the subject profile and the defined needs/objectives of the subject, the content of the personalized program of adapted feeding activities comprising at least a schedule of food intakes associated with food menu suggestions;
define temporal articulation variables, in accordance with the subject profile allowing, over a predefined time interval, to articulate, according to the predefined time interval, the structured program of adapted physical activities and the personalized program of feeding activities, and to articulate and within the sessions of adapted physical activities and feeding activities;
generate the structured program of adapted physical activities and the personalized program of adapted feeding activities based on the temporal articulation variables; and
provide a session of structured adapted physical activities to be performed, articulated with a feeding activity based on the temporal articulation variables, to the subject via the user interface;
at least one of physiological and motion sensors to capture at least one of a physical state and a physical activity of the subject;
wherein the processing unit iteratively performs the following:
commands said at least one of physiological and motion sensors to capture said at least one of a physical state and a physical activity of the subject during the session of the structured adapted physical activities of the structured program;
adjusts, during the session, the structured adapted physical activities of the session in progress, via the user terminal, based on said at least one of physical state and physical activity data of the subject captured by said at least one of physiological and motion sensors;
adjusts a feeding activity associated with the structured adapted physical activity of the session in progress;
adjusts temporal articulation variables of the structured adapted physical activities and of the feeding activities within the session; and
provides the subject, on the user interface, with the adjusted content of the structured adapted physical activities of the session in progress and of the feeding activities associated with said at least one at least one of physical state and physical activity data of the subject captured by said at least one of physiological and motion sensors.
